(19) United States
(12) Patent Application Publication
(10) Pub. No.: US 2026/0359456 A1
(43) Pub. Date: Nov. 12, 2026

(54) GENERATING AND MANAGING TENANT WORKBOOK MANAGEMENT INSTANCES

(71) Applicants: IOANA CRISTINA MUNTEANU, SAN FRANCISCO, CA (US); MATTHEW C. JONES, SAN FRANCISCO, CA (US); JAMES A. JOHNSON, CONCORD, CA (US); ASAD AKRAM, BERKELEY HEIGHTS, CA (US); ZALAK H. TRIVEDI, SAN LEANDRO, CA (US)

(72) Inventors: IOANA CRISTINA MUNTEANU, SAN FRANCISCO, CA (US); MATTHEW C. JONES, SAN FRANCISCO, CA (US); JAMES A. JOHNSON, CONCORD, CA (US); ASAD AKRAM, BERKELEY HEIGHTS, CA (US); ZALAK H. TRIVEDI, SAN LEANDRO, CA (US)

(21) Appl. No.: 19/202,895

(22) Filed: May 8, 2025

Related U.S. Application Data
(60) Provisional application No. 63/787,118, filed on Apr. 11, 2025.

(51) Int. Cl. G06F 21/60

(52) U.S. Cl. CPC G06F 21/604; G06F 2221/2141

(57) ABSTRACT

Generating and managing tenant workbook management instances including receiving, by a workbook manager from a client computing system, a request to create a tenant workbook management instance of a client workbook management instance, wherein the client workbook management instance is an operational copy of the workbook manager managed by a client entity; generating, by the workbook manager, the tenant workbook management instance of the client workbook management instance and a tenant administrator account for the tenant workbook management instance, wherein the tenant workbook management instance is a subsidiary workbook management instance administered by the client workbook management instance; receiving, by the workbook manager from the tenant administrator account on a tenant computing system, an administrative request targeting the tenant workbook management instance; and servicing, by the workbook manager, the administrative request on the tenant workbook management instance.

### BACKGROUND

### Field of the Invention

The field of the invention is data processing, or, more specifically, methods, apparatus, and products for generating and managing tenant workbook management instances.

### Description of Related Art

Modern businesses may store large amounts of data in remote databases within cloud-based data warehouses. This data may be accessed using database statement languages, such as structured query language (SQL). Manipulating the data stored in the database may require constructing complex queries beyond the abilities of most users. Further, composing and issuing database queries efficiently may also be beyond the abilities of most users.

### SUMMARY

Methods, systems, and apparatus for generating and managing tenant workbook management instances including receiving, by a workbook manager from a client computing system, a request to create a tenant workbook management instance of a client workbook management instance, wherein the client workbook management instance is an operational copy of the workbook manager managed by a client entity; generating, by the workbook manager, the tenant workbook management instance of the client workbook management instance and a tenant administrator account for the tenant workbook management instance, wherein the tenant workbook management instance is a subsidiary workbook management instance administered by the client workbook management instance; receiving, by the workbook manager from the tenant administrator account on a tenant computing system, an administrative request targeting the tenant workbook management instance; and servicing, by the workbook manager, the administrative request on the tenant workbook management instance.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of an example system configured for generating and managing tenant workbook management instances according to embodiments of the present invention.

FIG. 2 sets forth a block diagram of an example system configured for generating and managing tenant workbook management instances according to embodiments of the present invention.

FIG. 3 sets forth a block diagram of an example system configured for generating and managing tenant workbook management instances according to embodiments of the present invention.

FIG. 4 sets forth a flow chart illustrating an exemplary method for generating and managing tenant workbook management instances according to embodiments of the present invention.

FIG. 5 sets forth a flow chart illustrating an exemplary method for generating and managing tenant workbook management instances according to embodiments of the present invention.

### DETAILED DESCRIPTION

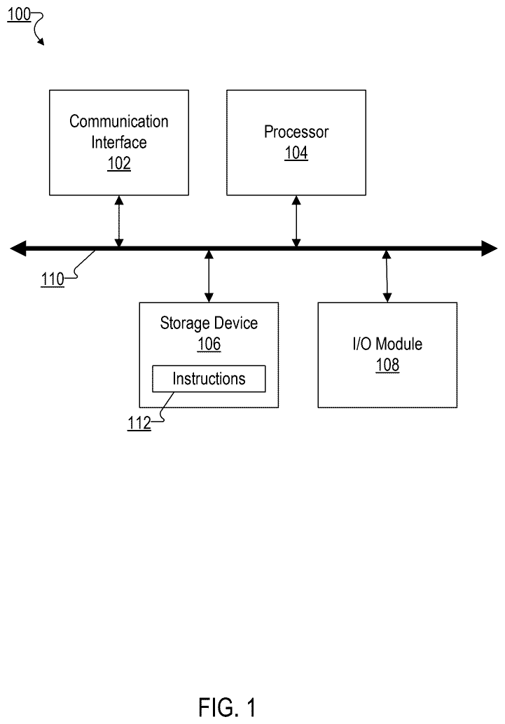

Example methods, apparatus, and products for generating and managing tenant workbook management instances in accordance with embodiments of the present disclosure are described with reference to the accompanying drawings, beginning with FIG. 1. FIG. 1 illustrates an exemplary computing device 100 that may be specifically configured to perform one or more of the processes described herein. As shown in FIG. 1, computing device 100 may include a communication interface 102, a processor 104, a storage device 106, and an input/output (“I/O”) module 108 communicatively connected one to another via a communication infrastructure 110. While an exemplary computing device 100 is shown in FIG. 1, the components illustrated in FIG. 1 are not intended to be limiting. Additional or alternative components may be used in other embodiments. Components of computing device 100 shown in FIG. 1 will now be described in additional detail.

Communication interface 102 may be configured to communicate with one or more computing devices. Examples of communication interface 102 include, without limitation, a wired network interface (such as a network interface card), a wireless network interface (such as a wireless network interface card), a modem, an audio/video connection, and any other suitable interface.

Processor 104 generally represents any type or form of processing unit capable of processing data and/or interpreting, executing, and/or directing execution of one or more of the instructions, processes, and/or operations described herein. Processor 104 may perform operations by executing computer-executable instructions 112 (e.g., an application, software, code, and/or other executable data instance) stored in storage device 106.

Storage device 106 may include one or more data storage media, devices, or configurations and may employ any type, form, and combination of data storage media and/or device. For example, storage device 106 may include, but is not limited to, any combination of non-volatile media and/or volatile media. Electronic data, including data described herein, may be temporarily and/or permanently stored in storage device 106. For example, data representative of computer-executable instructions 112 configured to direct processor 104 to perform any of the operations described herein may be stored within storage device 106. In some examples, data may be arranged in one or more databases residing within storage device 106.

I/O module 108 may include one or more I/O modules configured to receive user input and provide user output. I/O module 108 may include any hardware, firmware, software, or combination thereof supportive of input and output capabilities. For example, I/O module 108 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 108 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 100.

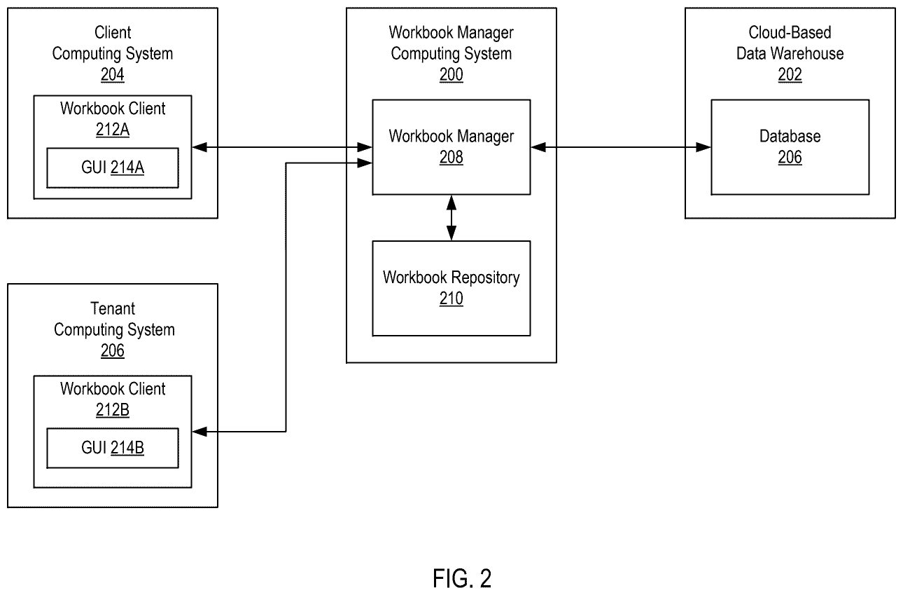

For further explanation, FIG. 2 illustrates a block diagram depicting an exemplary system for generating and managing tenant workbook management instances according to embodiments of the present invention. As shown in FIG. 2, the system includes a workbook manager computing system 200, a cloud-based data warehouse 202, a client computing system 204, and a tenant user computing system 206. The workbook manager computing system 200 includes a workbook manager 208 and a workbook repository 210. The client computing system 204 includes a workbook client 212A with a graphical user interface (GUI) 214A. The tenant user computing system 206 also includes a workbook client 212B with a GUI 214B. The cloud-based data warehouse 202 includes a database 204.

The workbook manager 208 is hardware, software, or an aggregation of hardware and software configured to present a dataset within a workbook on a client computing system 204 via the workbook client 212A, 212B. The workbook manager 208 uses the dataset to retrieve data from the database 206 by issuing a database statement to the cloud-based data warehouse 202 requesting the data. In response, the cloud-based data warehouse 202 sends query results including the data to the workbook manager 208. Once the query results are received, the data is then organized according to the dataset and workbook metadata to generate the workbook. The workbook is then sent to a workbook client 212a, 212b on the client computing system 204 or tenant computing system 206 for presentation to a user of the client computing system 204 or tenant user. The workbook manager 208 may reside on the workbook manager computing system 200, which is an intermediary computing system between each client computing system, each tenant user computing system, and the cloud-based data warehouse 202.

The specific realization of the workbook manager 208 that a particular client entity engages with is referred to as a client workbook management instance. A client workbook management instance is an operational copy of the workbook manager 208 managed by a client entity. The client workbook management instance may include configurations and settings used to access and store workbooks. The client workbook management instance may also include connections to access one or more cloud-based data warehouses 202. The client workbook management instance is managed by a client administrator account and is accessible by client user accounts.

The cloud-based data warehouse 202 stores and manages data on behalf of a data occupant. A data occupant (also referred to as a data tenant) is an entity that controls data on the cloud-based data warehouse. The user (e.g., via the client computing system 204) accesses the data via the workbook manager 208, which organizes and analyzes the data as datasets within a workbook. The user may be within the same organization as the data occupant (e.g., an employee of the company that owns and stores the data) or may be in a business relationship with the data occupant (e.g., an employee of a company that employs the data tenant for an enterprise service). The workbook manager 208 may access the data from the cloud-based data warehouse 202 using credentials supplied by the data occupant.

A workbook is a presentation of data from a cloud-based data warehouse 202. A workbook may include one or more workbook elements. Each workbook element includes a collection of graphical elements and organizing mechanism for a dataset or portion of a dataset. Workbooks may be stored in the workbook repository 210. Workbooks are described in further detail below.

To present data from the cloud-based data warehouse 202, the data is retrieved from the database 206 (e.g., using a database statement) and organized using a dataset. A dataset is an organizing mechanism for data and resides on the workbook manager computing system 200. The dataset may also include instructions for the retrieval of data from the cloud-based data warehouse 202. The dataset may include, for example, a network location of the cloud-based data warehouse 202, a structure in which to organize the data, and formulas or other data points to be included with the data. When the workbook is being presented, the dataset also includes the data retrieved from the cloud-based data warehouse.

The workbook client 212A, 212B is a part of the workbook manager 208 and works in concert with the workbook manager 208 to present a workbook on a client computing system 204. The workbook client 212A, 212B may perform local processing of changes made to the workbook and/or the dataset. The workbook client 212A, 212B may be an application executing within a web browser. The workbook client 212A, 212B may be part of an Internet application that includes the workbook manager 208 and is hosted on the workbook manager computing system 200.

The GUI 214A, 214B is a visual presentation configured to present datasets and workbooks to a client or tenant user. The GUI 214 may present a mechanism by which a user can manipulate and effect change to the workbook in the form of a workbook edit. The GUI 214 may be displayed on client computing system 204 or tenant computing system 206 (e.g., on a system display or mobile touchscreen).

The client computing system 204 is a computing system under the control of a client entity. The client entity is an entity with a direct relationship with the workbook manager 208 such that a client account within the client entity is authorized by the workbook manager 208 to access a workbook. The client entity may be a data occupant of the cloud-based data warehouse and control the dataset underlying the workbook.

The tenant computing system 206 is a computing system under the control of a tenant entity. The tenant entity may use the tenant computing system 206 to access a tenant workbook management instance of the client workbook management instance. A tenant workbook management instance is a subsidiary workbook management instance administered by the client workbook management instance. A client workbook management instance may have multiple tenant workbook management instances that are isolated from one another. Specifically, each tenant workbook management instance may have users, administrators, workbooks, and connections unique to the tenant workbook management instance and not shared with other tenant workbook management instances. The workbook management instance that creates a subsidiary workbook management instance may be referred to as a parent workbook management instance and the created subsidiary workbook management instance may be referred to as a child workbook management instance.

The database 206 is a collection of data and a management system for the data. Data may be organized into columns and rows (also referred to as records). The particular columns, rows, and organization of the columns and rows that make up data may be specified in the database statement requesting the data. Data may be sent from the cloud-based data warehouse 202 in response to a database statement (also referred to as a query). Accordingly, data retrieved in response to a database statement may be referred to as query results. The database statement may be a structured query language statement.

The workbook manager 208 and workbook clients 212a, 212b may exchange information using state specifications. A state specification is a collection of data describing inputs into the GUI 214. The state specification may include manipulations of GUI elements within the GUI 214 along with data entered into the GUI 214 by a user of the client computing system 204. Such manipulations and data may indicate requests for and manipulations of data and or workbooks. Such manipulations and data may also indicate requests to edit an existing row or create a new row and values for that row. The state specification may be a standard file format used to exchange data in asynchronous browser-server communication. For example, the state specification may be a JavaScript Object Notation specification. The state specification may also include descriptions of elements that are used to apply changes to the data and/or workbooks. Such elements may include filters applied to an element of the workbook, the hierarchical level of an element of the workbook, joins performed within an element of the workbook, exposable parameters in an element of the workbook, and security for the workbook.

The workbook manager 208 may use the state specification as input to compile a database statement. This database statement generation process may include a number of intermediate forms. For example, the database statement generation process may begin with state specification being converted into an abstract syntax tree. The abstract syntax tree may then be canonicalized into a canonicalized hierarchy. The canonicalized hierarchy may then be linearized into the workbook algebra. The workbook algebra may then be lowered into a relational algebra, which may then be lowered into the database statement.

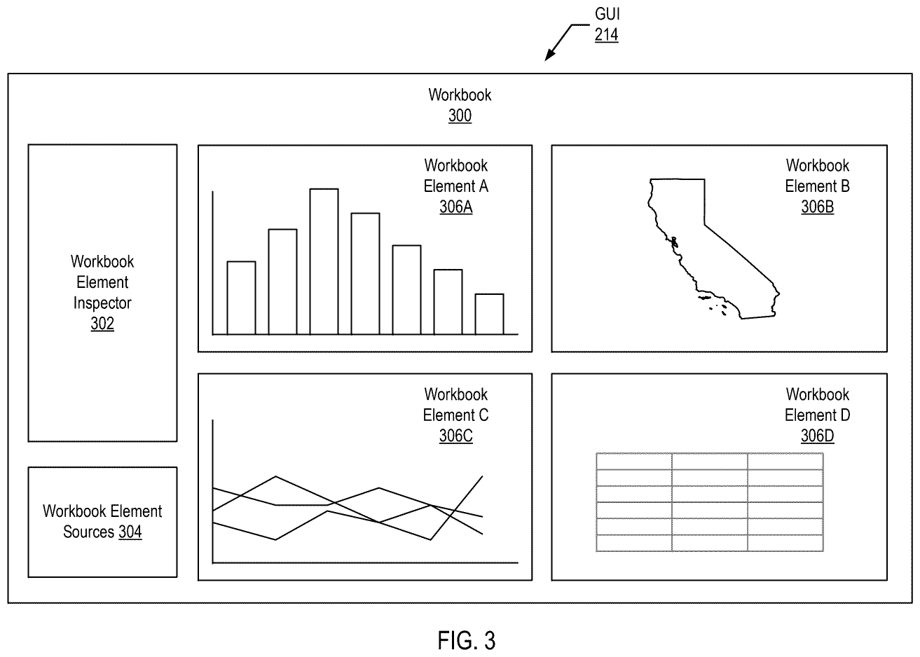

FIG. 3 shows an exemplary GUI for generating and managing tenant workbook management instances according to embodiments of the present invention. As shown in FIG. 3, the exemplary GUI 214 includes a workbook 300. The workbook 300 includes a workbook element inspector 302, workbook element sources 304, and four workbook elements (workbook element A 306A, workbook element B 306B, workbook element C 306C, workbook element D 306D).

The workbook 300 is a collection of graphical elements and organizing mechanism for a dataset. The workbook may present a dataset with data retrieved by the workbook manager from a cloud-based data warehouse. The dataset may then be organized based on the workbook metadata retrieved from the workbook repository. As shown in FIG. 3, the workbook 300 includes four workbook elements. Workbook element A 306A presents a bar graph, workbook element B 306B presents a map, workbook element C 306C presents a line graph, and workbook element D 306D presents a spreadsheet structure. Other types of workbook elements exist beyond the examples shown in FIG. 3. Some workbook elements (such as workbook element A 306A, workbook element B 306B, and workbook element C 306C) are visualizations. Visualizations are graphical elements that convey relationships between data in the dataset. Visualizations may include, for example, graphs, charts, or maps. Spreadsheet structures are a presentation of a dataset (such as a table) from a database on a cloud-based data warehouse. The spreadsheet structure displays rows of data organized by columns. The columns delineate different categories of the data in each row. One or more columns may be calculation columns that include calculation results using other columns in the spreadsheet structure based on a formula received from the client. Both visualizations and the spreadsheet structures may include dynamic elements and be configured to interact with a client using the client computing system 204 via the GUI 214. Each workbook element (workbook element A 306A, workbook element B 306B, workbook element C 306C, workbook element D 306D) may use a dataset unique to that workbook element or use a dataset shared by at least one other workbook element.

The workbook element inspector 302 is a mechanism by which a user may configure each workbook element. Specifically, the workbook element inspector 302 allows a user to bind dimensions of the dataset to channels of the workbook element. A dimension of the dataset refers to a group of values, rows, or columns that share a characteristic. For example, a dimension may be all values in the dataset from a particular column, all rows in the dataset that share a value for a particular column, all columns in the dataset that share a value for a particular row, etc. A channel of the workbook element 304, 306 refers to aspect of the workbook element that is assignable to a dimension. Channels of a spreadsheet structure may include columns or rows (e.g., a column of the dataset may be bound to a particular column location within the visual presentation of the spreadsheet structure). Channels of visualizations may include, for example, x-axis, y-axis, or color. For example, a column of a dataset may be bound to the x-axis of a bar chart.

The workbook element inspector 302 may include a mechanism to define and organize hierarchical relationships between the columns of a spreadsheet structure. The term “hierarchical relationship” refers to subordinate and superior groupings of columns. For example, a database may include rows for an address book, and columns for state, county, city, and street. A dataset from the database may be grouped first by state, then by county, and then by city. Accordingly, the state column would be at the highest level in the hierarchical relationship, the county column would be in the second level in the hierarchical relationship, and the city column would be at the lowest level in the hierarchical relationship.

The workbook element sources 304 presents the user with the primary and any secondary sources (such as datasets) for the selected workbook element. The workbook element sources 304 may also include a mechanism for a user to request and configure a dataset from a database to be presented as a workbook element in a workbook 300. Such a mechanism may be part of the interactivity of the workbook 300. Specifically, a user may manipulate a workbook (e.g., by dragging and dropping columns or rows, resorting columns or rows, manipulating a graph etc.) and, in response, the GUI 214 may generate a request (e.g., in the form of a state specification) for a dataset and send the request to the workbook manager. Such a mechanism may also include a direct identification of the rows and columns of a database table that a user would like to access (e.g., via a selection of the rows and columns in a dialog box). The GUI 214 may also include a mechanism for a user to create a new table on the database, add rows to a table, and move rows within the table.

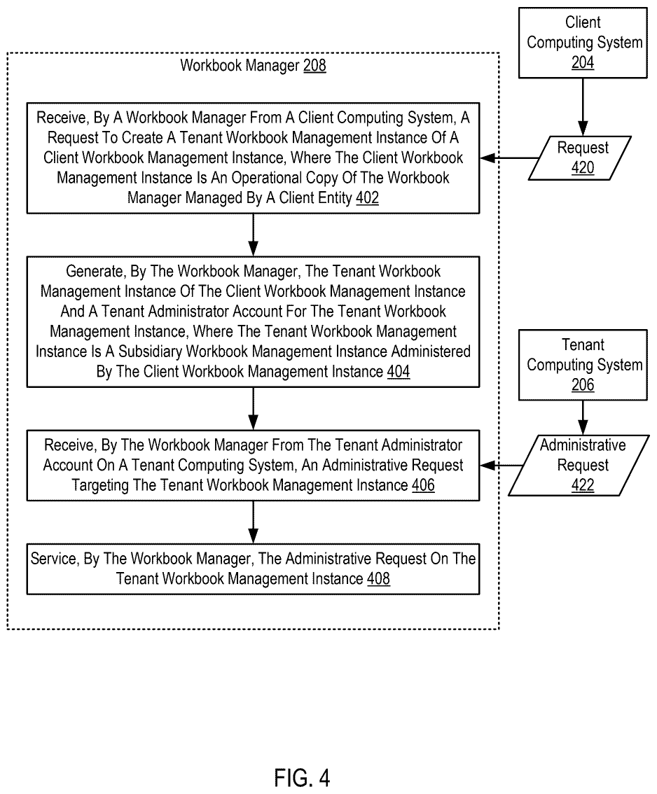

For further explanation, FIG. 4 sets forth a flow chart illustrating an exemplary method for generating and managing tenant workbook management instances according to embodiments of the present invention. The method of FIG. 4 includes receiving 402, by a workbook manager 208 from a client computing system 204, a request 420 to create a tenant workbook management instance of a client workbook management instance, wherein the client workbook management instance is an operational copy of the workbook manager 208 managed by a client entity. In one or more embodiments, receiving 402, from a client computing system 204, a request 420 to create a tenant workbook management instance of a client workbook management instance is carried out by the workbook manager 208 (operating as the client workbook management instance) generating the necessary data to instantiate a tenant workbook management instance of the client workbook management instance.

The request 420 to instantiate the tenant workbook management instance may include configuration data for the tenant workbook management instance. For example, the request 420 may grant user accounts of the tenant workbook management instance access to client assets, such as client workbooks. The request 420 may further include data to create new connections to one or more cloud-based data warehouses. The request 420 may also include data to create one or more tenant administrator accounts and tenant user accounts.

The method of FIG. 4 also includes generating 404, by the workbook manager 208, the tenant workbook management instance of the client workbook management instance and a tenant administrator account for the tenant workbook management instance, wherein the tenant workbook management instance is a subsidiary workbook management instance administered by the client workbook management instance. In one or more embodiments, generating 404 the tenant workbook management instance of the client workbook management instance and a tenant administrator account for the tenant workbook management instance is carried out by instantiating the tenant workbook management instance based on the client workbook management instance. The tenant workbook management instance may be created with some or all of the attributes and configurations of the client workbook management instance from which it is created. Further, some subsequent changes made to the client workbook management instance may be reflected in the tenant workbook management instance. Such changes may include, for example, changes to a workbook, changes to credentials to access external APIs or software services, or changes to the user interface.

The client workbook management instance may have different connections to cloud-based data warehouses than the tenant workbook management instance. Specifically, the client workbook management instance may include a first connections to a cloud-based data warehouse, and the tenant workbook management instance may include a different second connection to the cloud-based data warehouse or a different cloud-based data warehouse. As used herein, a connection refers to (at least) a network address and credentials to access a cloud-based data warehouse. The client workbook management instance and the tenant workbook management instance may include entirely different connections to the same or different cloud-based data warehouses.

A tenant administrator account is a user account for the tenant workbook management instance with elevated permissions. Such permissions may include the ability to create, edit, and remove tenant users of the tenant workbook management instance with lessor permissions. The tenant administrator account may lack access to the client workbook management instance. Similarly, any tenant user accounts created by the tenant administrator account or client administrator account may lack access to the client workbook management instance. The client administrator account may be configured with the same or greater permissions with regard to the tenant workbook management instance than the tenant administrator account.

The tenant workbook management instance may be created with a schema that matches the schema used by the client workbook management instance. Specifically, the database used by the tenant workbook management instance may be named and organized in the same or similar manner as the database used by the client workbook management instance. Matching schemas enables a client workbook that presents data using the client's connection and the client's cloud-based data warehouse to be used on the tenant workbook management instance using the tenant's connection to the tenant's cloud-based data warehouse. The workbooks would appear and operate in the same way except for the data being presented and analyzed.

The method of FIG. 4 also includes receiving 406, by the workbook manager 208 from the tenant administrator account on a tenant computing system 206, an administrative request 422 targeting the tenant workbook management instance. In one or more embodiments, receiving 406, from the tenant administrator account on a tenant computing system 206, an administrative request 422 targeting the tenant workbook management instance is carried out by the workbook manager 208 authenticating the tenant administrator account and determining that the tenant administrator account has the appropriate permissions to make the administrative request 422. By using the tenant administrator account to access the workbook manager 208, the workbook manager 208 that the tenant administrator account interacts with will be the tenant workbook management instance.

The administrative request 422 is a request to make changes to the workbook management instance that require elevated permissions. Administrative requests may include, for example, requests to create tenant user accounts for the tenant workbook management instance, set permissions for tenant user accounts, and create connections for the tenant workbook management instance. Administrative requests may even include a request to instantiate a child workbook management instance of the tenant workbook management instance.

The method of FIG. 4 also includes servicing 408, by the workbook manager 208, the administrative request 422 on the tenant workbook management instance. In one or more embodiments, servicing 408 the administrative request 422 on the tenant workbook management instance is carried out by implementing the administrative request 422 on the tenant workbook management instance. This may include, for example, creating tenant user accounts for the tenant workbook management instance, setting permissions for tenant user accounts, or creating connections for the tenant workbook management instance.

The above steps improve the operation of the computer system by allowing an operator of a workbook management instance to create child workbook management instances to isolate sections of the organization from each other. This is accomplished by instantiating the workbook management instance based on the parent workbook management instance and granting an administrator account for the child workbook management instance the ability to manage the child workbook management instance.

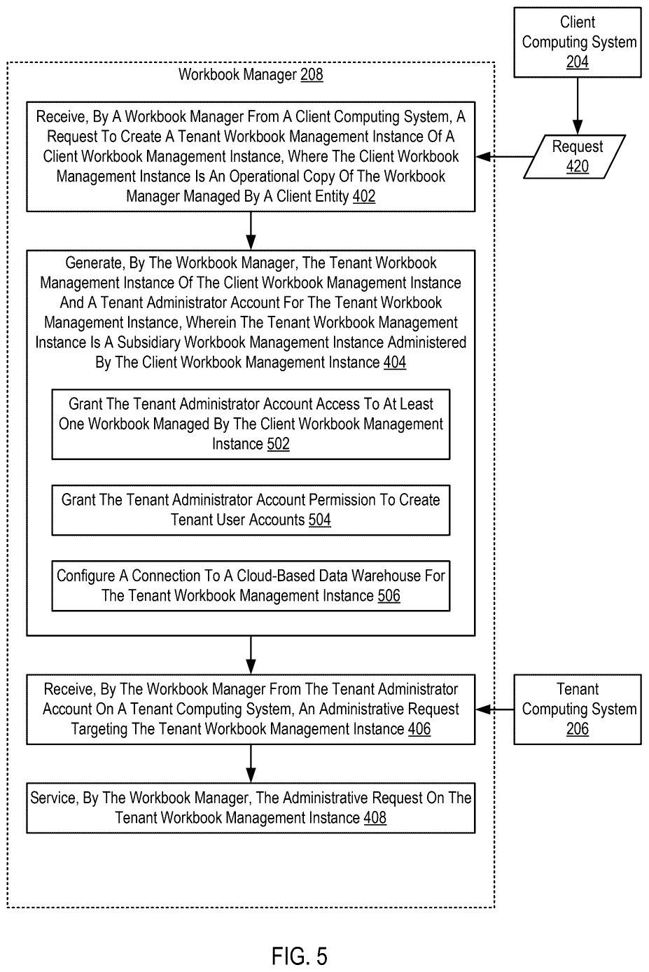

For further explanation, FIG. 5 sets forth a flow chart illustrating a further exemplary method for generating and managing tenant workbook management instances according to embodiments of the present invention that includes receiving 402, by a workbook manager 208 from a client computing system 204, a request 420 to create a tenant workbook management instance of a client workbook management instance, wherein the client workbook management instance is an operational copy of the workbook manager 208 managed by a client entity; generating 404, by the workbook manager 208, the tenant workbook management instance of the client workbook management instance and a tenant administrator account for the tenant workbook management instance, wherein the tenant workbook management instance is a subsidiary workbook management instance administered by the client workbook management instance; receiving 406, by the workbook manager 208 from the tenant administrator account on a tenant computing system 206, an administrative request 422 targeting the tenant workbook management instance; and servicing 408, by the workbook manager 208, the administrative request 422 on the tenant workbook management instance.

The method of FIG. 5 differs from the method of FIG. 4, however, in that generating 404, by the workbook manager 208, the tenant workbook management instance of the client workbook management instance and a tenant administrator account for the tenant workbook management instance includes granting 502 the tenant administrator account access to at least one workbook managed by the client workbook management instance; granting 504 the tenant administrator account permission to create tenant user accounts; and configuring 506 a connection to a cloud-based data warehouse for the tenant workbook management instance.

In one or more embodiments, granting 502 the tenant administrator account access to at least one workbook managed by the client workbook management instance is carried out by a client administrator accessing permissions associated with the workbook and indicating within the permissions that the workbook may be accessed by the tenant administrator account. Alternatively, the creation of the tenant administrator account may automatically grant that account with permission to access some or all workbooks on the client workbook management instance. Once permission is granted, the tenant administrator account may access the tenant workbook management instance and configure the workbook for use by tenant user accounts. Configuring the workbook may include mapping the workbook to the cloud-based data warehouse used by the tenant workbook management instance.

In one or more embodiments, granting 504 the tenant administrator account permission to create tenant user accounts is carried out by client administrator accessing permissions associated with the tenant administrator account and indicating within the permissions that the tenant administrator account is authorized to create tenant users that have access to the tenant workbook management instance. Alternatively, the client administrator accessing permissions associated with the tenant workbook management instance and indicating within the permissions that tenant users may be created and administered by the tenant administrator account. In yet another alternative, the creation of the tenant administrator account may automatically grant that account permission to create tenant users with access to the tenant workbook management instance. Once the permission is granted, the tenant administrator account may create tenant user accounts that are authorized to access workbooks and accessible data within the tenant workbook management instance. The tenant administrator account may specify the level of permissions for each user account (e.g., complete or limited access to the tenant workbook management instance).

In one or more embodiments, configuring 506 a connection to a cloud-based data warehouse for the tenant workbook management instance is carried out by the workbook manager using connection information to store a connection usable by the tenant administrator account and tenant user accounts. As part of configuring the tenant workbook management instance, a client administrator may supply the workbook manager with connection information that the workbook manager then uses to generate the connection within the tenant workbook management instance. The connection or connections used by the tenant workbook management instance may be separate and distinct from the connection or connections used by the client workbook management instance.

Consider the following examples. A large corporation (i.e., a client entity) may provide workbooks in the form of dashboards to employees (i.e., client accounts) that track various metrics for the corporation. That corporation may have a development team tasked with developing the dashboards. To create a development environment for the dashboards isolated from the production version of the dashboards, an administrator for the corporation workbook management instance may generate a tenant workbook management instance for use as a development environment for the development team to test updates to the production version of the dashboards within the corporation workbook management instance. The development environment may use a connection to the corporation's cloud-based data warehouse that lacks access to live corporate data, but rather accesses artificial data to safeguard customer privacy.

The administrator for the corporation workbook management instance may send a request to create the development (tenant) workbook management instance. The workbook manager then creates the development workbook management instance and a tenant administrator account that may be used by a development head. The development head may use the tenant administrator account to configure the development environment of the development workbook management instance. Once a new version of the dashboard has been tested and is ready for deployment, that version may be promoted from the development workbook management instance to the corporation workbook management instance.

As another example, a large multinational bank may want to isolate different branches of the bank's divisions, such as investment banking and international banking. An administrator for the parent bank workbook management instance may request that the workbook manager create an investment banking workbook management instance and an international banking workbook management instance and associated administrators. This would enable the different divisions to be isolated from one another, but both be managed and governed by administrators of the parent bank workbook management instance. Specifically, the parent bank administrator account may access each child workbook management instance to configure the instances for governance and security purposes, including ensuring that each connection (and other network communications) complies with the necessary legal obligations.

In view of the explanations set forth above, readers will recognize that the benefits of generating and managing tenant workbook management instances according to embodiments of the present invention include:
Improving the operation of the computer system by allowing an operator of a workbook management instance to create child workbook management instances to isolate sections of the organization from each other, increasing system utility.

Exemplary embodiments of the present invention are described largely in the context of a fully functional computer system for generating and managing tenant workbook management instances. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Advantages and features of the present disclosure can be further described by the following statements:
1. A method of receiving, by a workbook manager from a client computing system, a request to create a tenant workbook management instance of a client workbook management instance, wherein the client workbook management instance is an operational copy of the workbook manager managed by a client entity; generating, by the workbook manager, the tenant workbook management instance of the client workbook management instance and a tenant administrator account for the tenant workbook management instance, wherein the tenant workbook management instance is a subsidiary workbook management instance administered by the client workbook management instance; receiving, by the workbook manager from the tenant administrator account on a tenant computing system, an administrative request targeting the tenant workbook management instance; and servicing, by the workbook manager, the administrative request on the tenant workbook management instance.
2. The method of statement 1, wherein the client workbook management instance comprises at least one client account, at least one workbook, and at least one connection to a cloud-based data warehouse.
3. The method of statement 2 or statement 1, wherein the client workbook management instance comprises a first connection to a cloud-based data warehouse, and wherein the tenant workbook management instance comprises a second connection to the cloud-based data warehouse.
4. The method of statement 3, statement 2, or statement 1, wherein the tenant administrator account lacks access to the client workbook management instance.
5. The method of statement 4, statement 3, statement 2, or statement 1, wherein the administrative request is an instruction to create a user account for the tenant workbook management instance.
6. The method of statement 5, statement 4, statement 3, statement 2, or statement 1, wherein generating the tenant administrator account comprises granting the tenant administrator account access to at least one workbook managed by the client workbook management instance.
7. The method of statement 6, statement 5, statement 4, statement 3, statement 2, or statement 1, wherein generating the tenant administrator account comprises granting the tenant administrator account permission to create tenant user accounts.
8. The method of statement 7, statement 6, statement 5, statement 4, statement 3, statement 2, or statement 1, wherein generating the tenant workbook management instance comprises configuring a connection to a cloud-based data warehouse for the tenant workbook management instance.
9. The method of statement 8, statement 7, statement 6, statement 5, statement 4, statement 3, statement 2, or statement 1, wherein the request to create the tenant workbook management instance is associated with a client administrator account for the client workbook management instance.
10. The method of statement 9, statement 8, statement 7, statement 6, statement 5, statement 4, statement 3, statement 2, or statement 1, wherein changes to the client workbook management instance are reflected in the tenant workbook management instance.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method comprising:
receiving, by a workbook manager from a client computing system, a request to create a tenant workbook management instance of a client workbook management instance, wherein the client workbook management instance is an operational copy of the workbook manager managed by a client entity;
generating, by the workbook manager, the tenant workbook management instance of the client workbook management instance and a tenant administrator account for the tenant workbook management instance, wherein the tenant workbook management instance is a subsidiary workbook management instance administered by the client workbook management instance;
receiving, by the workbook manager from the tenant administrator account on a tenant computing system, an administrative request targeting the tenant workbook management instance; and
servicing, by the workbook manager, the administrative request on the tenant workbook management instance.

2. The method of claim 1, wherein the client workbook management instance comprises at least one client account, at least one workbook, and at least one connection to a cloud-based data warehouse.

3. The method of claim 1, wherein the client workbook management instance comprises a first connection to a cloud-based data warehouse, and wherein the tenant workbook management instance comprises a second connection to the cloud-based data warehouse.

4. The method of claim 1, wherein the tenant administrator account lacks access to the client workbook management instance.

5. The method of claim 1, wherein the administrative request is an instruction to create a user account for the tenant workbook management instance.

6. The method of claim 1, wherein generating the tenant administrator account comprises granting the tenant administrator account access to at least one workbook managed by the client workbook management instance.

7. The method of claim 1, wherein generating the tenant administrator account comprises granting the tenant administrator account permission to create tenant user accounts.

8. The method of claim 1, wherein generating the tenant workbook management instance comprises configuring a connection to a cloud-based data warehouse for the tenant workbook management instance.

9. The method of claim 1, wherein the request to create the tenant workbook management instance is associated with a client administrator account for the client workbook management instance.

10. The method of claim 1, wherein changes to the client workbook management instance are reflected in the tenant workbook management instance.

11. A system comprising:
a memory; and
a processing device, operatively coupled to the memory, the processing device configured to:
receive, from a client computing system, a request to create a tenant workbook management instance of a client workbook management instance, wherein the client workbook management instance is an operational copy of a workbook manager managed by a client entity;
generate the tenant workbook management instance of the client workbook management instance and a tenant administrator account for the tenant workbook management instance, wherein the tenant workbook management instance is a subsidiary workbook management instance administered by the client workbook management instance;
receive, from the tenant administrator account on a tenant computing system, an administrative request targeting the tenant workbook management instance; and
service the administrative request on the tenant workbook management instance.

12. The system of claim 11, wherein the client workbook management instance comprises at least one client account, at least one workbook, and at least one connection to a cloud-based data warehouse.

13. The system of claim 11, wherein the client workbook management instance comprises a first connection to a cloud-based data warehouse, and wherein the tenant workbook management instance comprises a second connection to the cloud-based data warehouse.

14. The system of claim 11, wherein the tenant administrator account lacks access to the client workbook management instance.

15. The system of claim 11, wherein the administrative request is an instruction to create a user account for the tenant workbook management instance.

16. The system of claim 11, wherein generating the tenant administrator account comprises granting the tenant administrator account access to at least one workbook managed by the client workbook management instance.

17. The system of claim 11, wherein generating the tenant administrator account comprises granting the tenant administrator account permission to create tenant user accounts.

18. The system of claim 11, wherein generating the tenant workbook management instance comprises configuring a connection to a cloud-based data warehouse for the tenant workbook management instance.

19. The system of claim 11, wherein the request to create the tenant workbook management instance is associated with a client administrator account for the client workbook management instance.

20. A non-transitory computer readable storage medium storing instructions which, when executed, cause a processing device to:
receive, from a client computing system, a request to create a tenant workbook management instance of a client workbook management instance, wherein the client workbook management instance is an operational copy of a workbook manager managed by a client entity;
generate the tenant workbook management instance of the client workbook management instance and a tenant administrator account for the tenant workbook management instance, wherein the tenant workbook management instance is a subsidiary workbook management instance administered by the client workbook management instance;
receive, from the tenant administrator account on a tenant computing system, an administrative request targeting the tenant workbook management instance; and
service the administrative request on the tenant workbook management instance.
